(19) United States
(12) Patent Application Publication
(10) Pub. No.: US 2008/0122892 A1
(43) Pub. Date: May 29, 2008

(54) Inkjet-Type Recording Apparatus, Apparatus for Cleaning Inkjet Head Portion, and Method of Cleaning Inkjet Head Portion

(75) Inventor: Yasuhiro Sakamoto, Osaka (JP)

Correspondence Address: EDWARDS ANGELL PALMER & DODGE LLP, P.O. BOX 55874, BOSTON, MA, 02205, US

(73) Assignee: Sharp Kabushiki Kaisha, Osaka (JP)

(21) Appl. No.: 11/795,300

(22) PCT Filed: Jan. 6, 2006
(86) PCT No.: PCT/JP06/00054

§ 371 Date: Jul. 13, 2007

(30) Foreign Application Priority Data
Jan. 13, 2005 (JP) 2005-006640

(51) Int. Cl. B41J 2/165

(52) U.S. Cl. 347/33

(57) ABSTRACT

An inkjet-type recording apparatus includes an inkjet head portion (3), an ink tank (5) supplying the inkjet head portion (3) with ink (4), and a rotating roller (8) for cleaning a nozzle plate (1) of the inkjet head portion (3). The rotating roller (8) is arranged to face the nozzle plate (1) of the inkjet head portion (3) in a non-contact state. In addition, the rotating roller (8) is arranged to be closest to the nozzle plate (1) in an area other than a nozzle hole (2).

### TECHNICAL FIELD

The present invention relates to an inkjet-type recording apparatus, an apparatus for cleaning an inkjet head portion, and a method of cleaning an inkjet head portion.

### BACKGROUND ART

A drop-on-demand type in which necessary ink is ejected only at the time of printing has attracted attention in recent days from a point of view of such advantages as printing efficiency, lower cost, and lower running cost, and a thermal jet type (see Japanese Patent Laying-Open No. 55-027282) and a Kaiser type employing a piezoelectric element (see Japanese Patent Laying-Open No. 55-086765) have been in the mainstream. An inkjet head adapted to an inkjet type as such has a nozzle plate in which a plurality of nozzles for injecting ink are formed. Here, a direction of ejection of ink may be bent or ejection fails due to adhesion of the ink around the nozzle holes or adhesion of thickened ink or aggregation of pigment contained in the ink.

As a remedy for such defective ejection, head maintenance in which the nozzle plate is wiped with a wiping blade is generally carried out. With the conventional technique, however, when the wiping blade wipes the nozzle plate, the ink, thickened ink, aggregation of pigment contained in the ink, dust, or the like adheres to and contaminates the wiping blade, which results in lower wiping performance. In addition, contaminants that have adhered to the wiping blade in turn contaminate or damage the nozzle plate.

In order to address such problems, a maintenance method in which a rotating roller member formed of an ink absorber removes dust or ink droplet that has adhered to a nozzle plate, in a non-contact state or a contact state (see Japanese Patent Laying-Open No. 10-264407), and a maintenance method in which dust that has adhered to a nozzle hole or an area in the vicinity of the nozzle hole is removed by bringing closer a rotating roller member coated with a wash to the nozzle hole in a nozzle plate so that the wash has shear force (see Japanese Patent Laying-Open No. 2000-094703) have been proposed.

Among the conventional maintenance measures for addressing defective ejection, in a mechanism for wiping the nozzle plate with a wiper, it has been necessary to strictly control hardness of a wiper member, resistance to ink, and a pressure at which the wiper is brought into contact with the nozzle plate. In addition, so long as a separate member such as a wiper comes in contact with the nozzle plate, damage to the nozzle plate has been inevitable and bending of the ejection direction or failure in ejection has been caused.

Meanwhile, a mechanism for wipe-off by bringing an absorber rotating roller in contact with a nozzle can prevent ink from being left on a nozzle plate. On the other hand, if quick-dry ink, ink containing an uncured resin component, or ink containing pigment is employed, sudden thickening of the ink or aggregation of the pigment occurs on the surface of the absorber rotating roller, and adhesion again of the thickened ink to the nozzle plate or aggregation of the pigment may damage the nozzle plate.

Further, even if the absorber rotating roller is cleaned by a wringer member or with a wash, it is difficult to completely remove contaminants such as ink that has adhered, in particular when the absorber rotating roller has a complicated shape as sponge. Accordingly, in using the ink including an uncured resin component or the like or the ink containing pigment, thickening of the ink or aggregation of the pigment occurs on the surface of the cleaned absorber rotating roller, and adhesion of the thickened ink or aggregated pigment to the nozzle plate or damage to the nozzle plate may occur in a next maintenance operation.

In addition, as the absorber rotating roller cannot completely be cleaned, thickened ink or aggregation of the pigment is generated on the absorber rotating roller, which results in adhesion again thereof to the nozzle plate. Moreover, the absorber itself is chemically deteriorated by the ink, or the absorber is broken down into pieces by the mechanism for wringing the absorber. Then, the absorber rotating roller itself turns into a dust generation source and in turn contamination of the inkjet head is caused.

When the rotating roller member coated with a wash is brought closer to the nozzle plate for head maintenance, the wash such as an ink solvent is used. Accordingly, interdiffusion of the wash and the ink in the head occurs, and a large amount of ink is discarded, ejected and consumed after maintenance. Meanwhile, in the case of ink in which pigment is dispersed, balance between dispersant concentration and the content of the pigment is lost. Then, the pigment aggregates in the head and instead dust is generated in the head, which results in clogging of the nozzle hole with the aggregated pigment.

In order to solve the problems of conventional head maintenance, a head maintenance method for cleaning the nozzle plate, in which ink is not ejected as droplets but spread in a liquid state from the nozzle hole and the ink is again suctioned through the nozzle hole has also been proposed (see Japanese Patent Laying-Open No. 03-293140).

### Patent Document 1: Japanese Patent Laying-Open No. 55-027282

### Patent Document 2: Japanese Patent Laying-Open No. 55-086765

### Patent Document 3: Japanese Patent Laying-Open No. 10-264407

### Patent Document 4: Japanese Patent Laying-Open No. 2000-094703

### Patent Document 5: Japanese Patent Laying-Open No. 03-293140

### DISCLOSURE OF THE INVENTION

### Problems to be Solved by the Invention

The method of suctioning again the ink that has spread in a liquid state over the nozzle plate through the nozzle hole is capable of cleaning solely a portion around the nozzle hole, however, it is difficult to control an extent of ink that spreads in a liquid state around the nozzle hole in that, if the ink spreads over an area greater than the nozzle hole, ink is left on the nozzle plate. In addition, if dust or the like adheres to the area around the nozzle hole, dust is suctioned into the nozzle hole together with the ink and the nozzle hole is clogged.

The present invention was made in view of the above-mentioned problems, and an object of the present invention is to provide an inkjet-type recording apparatus, an apparatus for cleaning an inkjet head portion, and a method of cleaning an inkjet head portion capable of well removing accretion of dust or the like that has adhered to the inkjet head portion in cleaning the inkjet head portion.

### Means for Solving the Problems

In one aspect, an inkjet-type recording apparatus according to the present invention includes: an inkjet head portion making a recording on a recording medium by injecting ink from a nozzle hole in a nozzle plate; an ink tank supplying the inkjet head portion with ink; and a rotating roller for cleaning the nozzle plate of the inkjet head portion. The rotating roller is arranged to face the nozzle plate of the inkjet head portion in a non-contact state, and the rotating roller is arranged to be closest to the nozzle plate in an area other than a nozzle hole portion.

Preferably, with respect to the nozzle hole, a position where the rotating roller is closest to the nozzle plate is displaced with respect to the nozzle hole in a direction of rotation of the rotating roller.

In addition, preferably, a distance between the rotating roller and the nozzle plate increases from one axial end surface of the rotating roller toward another axial end surface. Preferably, a contact angle between the ink and the rotating roller is smaller than a contact angle between the ink and the nozzle plate. Preferably, a contact angle between the ink and the nozzle plate is at least 90°. Preferably, an ink removal portion removing the ink that has adhered to a surface of the rotating roller by contacting the surface of the rotating roller is further included.

In one aspect, an apparatus for cleaning an inkjet head portion according to the present invention includes: a rotating roller arranged to face a nozzle plate for inkjet in a non-contact state and arranged to be closest to the nozzle plate in an area other than a hole in the nozzle plate; an ink removal portion removing ink that has adhered to a surface of the rotating roller; and an ink storage portion storing the ink that has been removed by the ink removal portion.

In one aspect, a method of cleaning an inkjet head portion according to the present invention is a method of cleaning an inkjet head portion with a movable portion arranged to face a nozzle plate at a distance therefrom, and ink is removed from the nozzle plate while the ink between the movable portion and the nozzle plate is caused to adhere to a surface of the movable portion by moving the movable portion.

Preferably, the method of cleaning the inkjet head portion having a nozzle hole formed by using a rotating roller includes the steps of: arranging the rotating roller to face the inkjet head portion in a non-contact state; filling a gap between the nozzle plate and the rotating roller with ink ejected from the nozzle hole; gradually moving the ink filling the gap between the nozzle plate and the rotating roller from a position on the nozzle plate toward the rotating roller side; and removing the ink filling the gap between the rotating roller and the nozzle plate in an area other than where the nozzle hole is formed, in an area on the nozzle plate. Preferably, the rotating roller rotates at a speed of at most 30 mm/s.

Preferably, the ink is removed while a positive pressure is applied to the ink in the inkjet head portion.

### EFFECTS OF THE INVENTION

According to the inkjet-type recording apparatus, the apparatus for cleaning the inkjet head portion, and the method of cleaning the inkjet head portion of the present invention, dust or the like adhered to the inkjet head portion can satisfactorily be removed.

### BRIEF DESCRIPTION OF THE DRAWINGS

FIG. 1 is a cross-sectional view of an inkjet-type recording apparatus according to a first embodiment.

FIG. 2 is a cross-sectional view showing a first step of a cleaning step.

FIG. 3 is a cross-sectional view of an area around a nozzle plate 1, for showing a second step of the step of cleaning an inkjet head.

FIG. 4 is a cross-sectional view of the area around nozzle plate 1, for showing a third step of the step of cleaning the inkjet head.

FIG. 5 is a cross-sectional view showing a fourth step of the step of cleaning the inkjet head.

FIG. 6 is a cross-sectional view showing a fifth step of the step of cleaning the inkjet head.

FIG. 7 is an enlarged view of the area around the nozzle plate in the cross-sectional view shown in FIG. 6.

FIG. 8 is a cross-sectional view of an inkjet-type recording apparatus according to a second embodiment.

FIG. 9 is a side, cross-sectional view of an inkjet-type recording apparatus according to a third embodiment.

### DESCRIPTION OF THE REFERENCE SIGNS

1 nozzle plate; 2 nozzle hole; 3 inkjet head; 4 ink; 5 ink tank; 6 ink supply pipe; 7 accretion; 8 rotating roller; 9 rotation axis; 10 rubber blade; 12 discarded ink reception portion; 100 inkjet-type recording apparatus; 10 cleaning apparatus; and α, β contact angle.

### BEST MODES FOR CARRYING OUT THE INVENTION

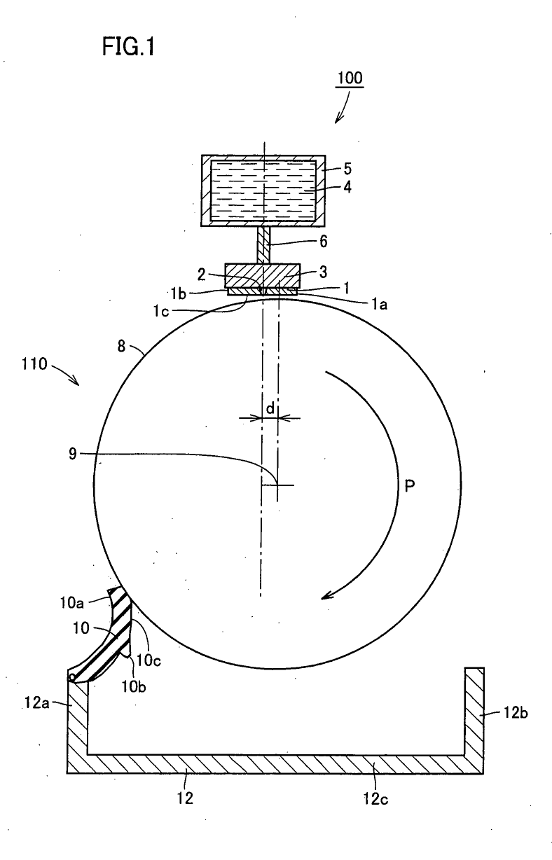

An embodiment of the present invention will be described with reference to FIGS. 1 to 9.

### First Embodiment

FIG. 1 is a cross-sectional view of an inkjet-type recording apparatus 100 according to a first embodiment. As shown in FIG. 1, inkjet-type recording apparatus 100 includes an inkjet head 3 making a recording on a not-shown recording medium by injecting ink 4 from a nozzle hole 2 of a nozzle plate 1, an ink tank 5 supplying inkjet head (inkjet head portion) 3 with ink 4, an ink supply pipe 6 provided between ink tank 5 and inkjet head 3, and a cleaning apparatus 110 cleaning nozzle plate 1 of inkjet head 3.

Cleaning apparatus 10 includes a rotating roller 8 arranged to face nozzle plate 1 of inkjet head 3 in a non-contact state and to be closest to nozzle plate 1 in an area other than nozzle hole 2 formed in nozzle plate 1. In addition, cleaning apparatus 10 includes a rubber blade (ink removal portion) 10 removing ink 4 that has adhered to the surface of rotating roller 8 and a discarded ink reception portion 12 storing ink 4 removed by rubber blade 10.

Rotating roller 8 is supported so as to be rotatable, by a not-shown drive portion, around a rotation axis 9 in a rotation direction P. In addition, rotating roller 8 is made of a hard material such as metal, e.g., stainless steel, glass, ceramics, and resin, and formed in a cylindrical shape. Rotating roller 8 is arranged along a longitudinal direction of nozzle plate 1 and the surface thereof is mirror-finished.

Nozzle plate 1 has a surface water-repellant-finished, and the surface of the nozzle plate is made of a water-repellant-finished polyimide film, polytetrafluoroethylene (PTFE), or the like. Water-based ink, oil-based ink, or ink of aromatic organic ether type is employed as ink 4, and ink 4 is mainly composed of an organic solvent with content of solid such as pigment, a polymerization-reactive low molecular monomer component, and a high polymer resin component that is cured when dried. Accordingly, a contact angle between nozzle plate 1 and ink 4 is 90° or greater.

Here, at least the surface of rotating roller 8 is made of a hard material such as metal, while a lower surface 1c of nozzle plate 1 is water-repellant-finished. Therefore, a contact angle between the surface of rotating roller 8 and ink 4 is set smaller than a contact angle between lower surface 1c of nozzle plate 1 and ink 4. Namely, wettability of the surface of rotating roller 8 with respect to ink 4 is set higher than wettability of the surface of nozzle plate 1 with respect to ink 4. In addition, nozzle plate 1 is formed in an elongated shape, and includes lower surface 1c formed in a substantially rectangular shape and side surface 1a and side surface 1b provided in a manner continuing to lower surface 1c. Side surface 1a and side surface 1b of nozzle plate 1 are arranged facing away from each other, in terms of rotation direction P of rotating roller 8. Side surface 1a and side surface 1b are arranged with respect to nozzle hole 2, on the forward side and the rear side in terms of rotation direction P, respectively.

A plurality of nozzle holes 2 are formed in a central portion of lower surface 1c of nozzle plate 1 and arranged along the longitudinal direction of nozzle plate 1. A position where rotating roller 8 is closest to nozzle plate 1 is displaced in rotation direction P of rotating roller 8, with respect to nozzle hole 2 formed in nozzle plate 1. Namely, rotating roller 8 is closest to nozzle plate 1 at a position in lower surface 1c of nozzle plate 1, closer to side surface 1a side. Accordingly, in the vicinity of nozzle plate 1, rotation axis 9 of rotating roller 8 and nozzle hole 2 formed in nozzle plate 1 are arranged such that rotation axis 9 of rotating roller 8 is displaced by a distance d toward the forward side in terms of rotation direction P.

Discarded ink reception portion 12 opening toward rotating roller 8 is arranged on a lower surface side of rotating roller 8. Discarded ink reception portion 12 includes a bottom surface 12c and side surfaces 12a and 12b that stand erect from bottom surface 12c. Around the opening of discarded ink reception portion 12, side surface 12a is arranged on the forward side in terms of rotation direction P of rotating roller 8, while side surface 12b is arranged on the rear side in terms of rotation direction P of rotating roller 8. Rubber blade 10 is arranged at a tip end portion of side surface 12a of discarded ink reception portion 12. An upper end portion 10a of rubber blade 10 abuts on the surface of rotating roller 8 and removes ink 4 that has adhered to the surface of rotating roller 8.

In upper end portion 10a, a downwardly extending surface 10c extending downward from the surface of rotating roller 8 and a protrusion 10b provided at a lower end portion of downwardly extending surface 10c and protruding toward inside of discarded ink reception portion 12 are formed. Rubber blade 10 is made of perfluoro rubber having high chemical resistance.

In addition, inkjet-type recording apparatus 100 includes a not-shown pressure regulating mechanism regulating a pressure of ink 4 supplied to inkjet head 3. The pressure regulating mechanism regulates the pressure of ink 4 injected from nozzle hole 2, so that a desired pattern is printed on a recording medium such as print paper.

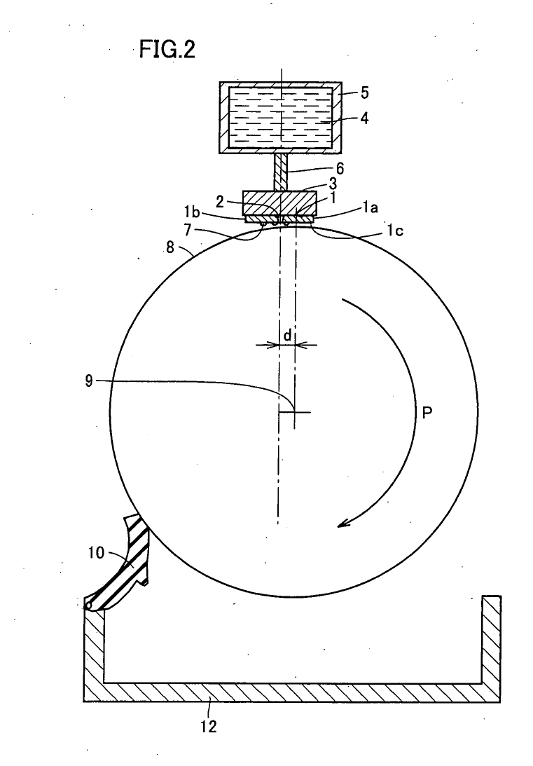

In inkjet-type recording apparatus 100 and inkjet head cleaning apparatus 110 structured as above, inkjet head 3 is cleaned as described below. FIGS. 2 to 7 show the step of cleaning inkjet head 3. FIG. 2 is a cross-sectional view showing a first step of the cleaning step. As shown in FIG. 2, rotating roller 8 is arranged so as not to come in contact with inkjet head 3. In the vicinity of nozzle plate 1, rotation axis 9 of rotating roller 8 is arranged with respect to nozzle hole 2, on the forward side in terms of rotation direction P. Namely, arrangement is such that the position where rotating roller 8 is closest to nozzle plate 1 is closer to side surface 1a side of lower surface 1c of nozzle plate 1. Here, small ink droplet (mist or satellite) or accretion 7 of dust or the like originating from an external environment adheres to lower surface 1c of nozzle plate 1. Accretion 7 has adhered to lower surface 1c of nozzle plate 1 in the course of recording on a recording medium such as print paper.

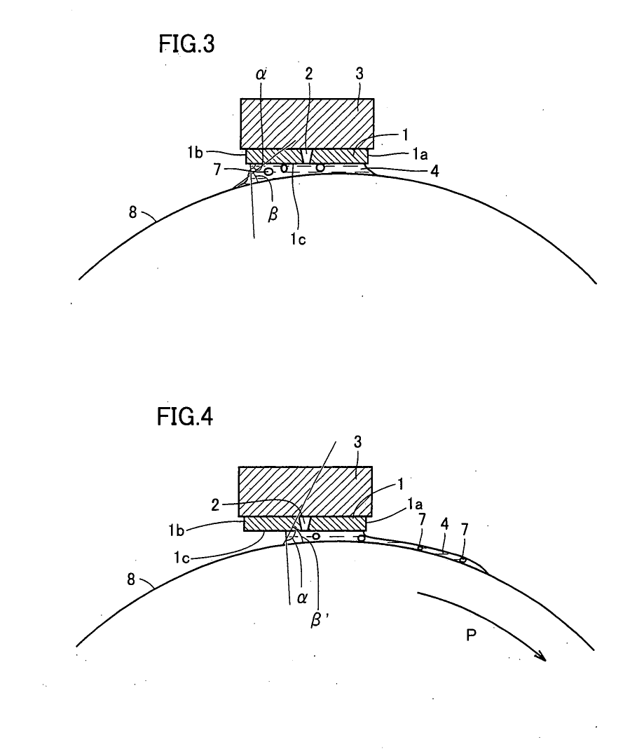

FIG. 3 is a cross-sectional view of an area around nozzle plate 1, for showing a second step of the step of cleaning inkjet head 3. As shown in FIG. 3, a pressure is applied to ink 4 in inkjet head 3 so as to eject ink 4 from nozzle hole 2 (prime operation).

Ejected ink 4 fills a gap between the surface of rotating roller 8 and lower surface 1c of nozzle plate 1. When ink 4 thus fills the gap between the surface of rotating roller 8 and lower surface 1c of nozzle plate 1, accretion 7 that has adhered to lower surface 1c of nozzle plate 1 is dispersed in ink 4.

In filling the gap between the surface of rotating roller 8 and nozzle plate 1 with ink 4, a positive pressure P1 such as a pressure in a range from at least several tens of KPa to at most several hundreds of KPa is applied to ink 4 in inkjet head 3. When the positive pressure is thus applied to ink 4 in nozzle plate 1, such meniscus of ink 4 as in a convex shape is formed at the opening of nozzle hole 2. Then, the tip end portion of ink 4 that swells outward at the opening of nozzle hole 2 comes in contact with the surface of rotating roller 8, and ink 4 spreads in a liquid state between rotating roller 8 and lower surface 1c of nozzle plate 1. Here, accretion 7 that has adhered inside nozzle hole 2 or to an area in the vicinity of nozzle hole 2 is washed away.

After the gap between the surface of rotating roller 8 and lower surface 1c of nozzle plate 1 is filled with ink 4, a positive pressure P2 such as a pressure in a range from at least 0.001 KPa to at most 5 KPa is applied to ink 4 in nozzle plate 1. Accordingly, introduction of ink 4 that fills the gap between the surface of rotating roller 8 and lower surface 1c of nozzle plate 1, accretion 7 dispersed in ink 4, or the like through nozzle hole 2 into nozzle plate 1 is suppressed.

As the surface of rotating roller 8 is made of a hard material and the surface of rotating roller 8 is like a mirror surface, impregnation of rotating roller 8 with ink 4 that fills the gap between the surface of rotating roller 8 and nozzle plate 1 is less likely. Therefore, an amount of ink 4 necessary for dispersing therein accretion 7 that has adhered to lower surface 1c of nozzle plate 1 is suppressed to a small amount.

In addition, as wettability of the surface of rotating roller 8 with respect to ink 4 is greater than wettability of the lower surface of nozzle plate 1 with respect to ink 4, a contact angle β between the surface of rotating roller 8 and ink 4 is smaller than a contact angle α between lower surface 1c of nozzle plate 1 and ink 4. For example, contact angle α between lower surface 1c of nozzle plate 1 and ink 4 is approximately 90°, while contact angle between the surface of rotating roller 8 and ink 4 is approximately 20°. Therefore, the ink filling the gap between rotating roller 8 and nozzle plate 1 spreads with its width increasing from nozzle plate 1 side toward rotating roller 8 side.

It is noted that contact angle β between rotating roller 8 and ink 4 refers to a contact angle between the surface of rotating roller 8 and a tail portion of ink 4 that fills the gap between rotating roller 8 and nozzle plate 1, on the rear side in terms of rotation direction P. In addition, contact angle α between lower surface 1c of nozzle plate 1 and ink 4 refers to a contact angle between nozzle plate 1 and a tail portion of ink 4 that fills the gap between the surface of rotating roller 8 and lower surface 1c of nozzle plate 1, on the rear side in terms of rotation direction P.

FIG. 4 is a cross-sectional view of the area around nozzle plate 1, in a third step of the step of cleaning inkjet head 3. As shown in FIG. 4, rotating roller 8 rotates around rotation axis 9 shown in FIG. 1 such that a speed of rotating roller 8 relative to nozzle plate 1 is not higher than 30 mm/s. Here, the surface of rotating roller 8 is higher in wettability with respect to ink 4 than lower surface 1c of nozzle plate 1. Accordingly, when rotating roller 8 rotates, ink 4 is carried while it adheres to the surface of rotating roller 8. Therefore, ink 4 that fills the gap between nozzle plate 1 and rotating roller 8 is gradually moved from the position on nozzle plate 1 toward rotating roller 8 side, and ink 4 is carried outward from the position between rotating roller 8 and lower surface 1c of nozzle plate 1, with accretion 7 being contained.

If the rotation speed of rotating roller 8 at the surface is not higher than 30 mm/s, viscosity of ink normally used in inkjet-type recording apparatus 100 is in a range from several cp to several tens of cp. Therefore, contact angle β is prevented from becoming greater than contact angle α, although the contact angle varies, along with rotation of rotating roller 8, in relation to the speed of spread in a liquid state over rotating roller 8 and the rotation speed of rotating roller 8.

The volume of ink 4 located between the surface of rotating roller 8 and lower surface 1c of nozzle plate 1 decreases with rotation of rotating roller 8. As the volume of ink 4 that fills the gap between rotating roller 8 and nozzle plate 1 decreases, the tail portion of ink 4 that fills the gap between rotating roller 8 and nozzle plate 1 on side surface 1a side draws back toward the rear side in terms of rotation direction P. Meanwhile, as rotating roller 8 rotates, the tail portion of ink 4 that fills the gap between rotating roller 8 and nozzle plate 1 on side surface 1b side advances toward the forward side in terms of rotation direction P.

Namely, as rotating roller 8 rotates, the tail portion of ink 4 located between rotating roller 8 and nozzle plate 1 on side surface 1a side and the tail portion thereof on side surface 1b side are displaced toward the position where rotating roller 8 is closest to lower surface 1c of nozzle plate 1. As rotating roller 8 rotates, an area of contact between ink 4 and nozzle plate 1 becomes smaller.

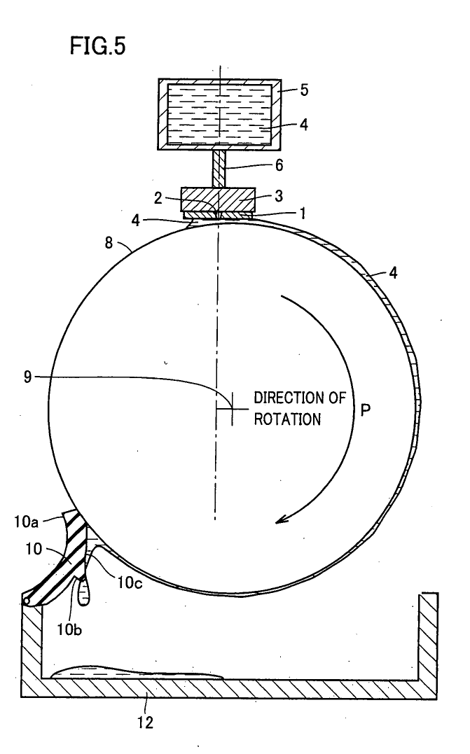

FIG. 5 is a cross-sectional view showing a fourth step of the step of cleaning inkjet head 3. As shown in FIG. 5, ink 4 adheres to the surface of rotating roller 8. Upper end portion 10a of rubber blade 10 abuts on the surface of rotating roller 8 and removes ink 4 that has adhered to the surface of rotating roller 8. Here, as the surface of rotating roller 8 is mirror-finished and it is made of such a hard material that impregnation with ink 4 is less likely, ink 4 that has adhered to the surface of rotating roller 8 is removed well by rubber blade 10. In particular, as rubber blade 10 is made of perfluoro rubber having high chemical resistance, the quality thereof is less likely to be altered by ink 4. Thus, ink 4 that has adhered to the surface of rotating roller 8 can reliably be removed.

As ink 4 that has adhered to the surface of rotating roller 8 can thus be removed well, generation of thickened ink or aggregation of pigment at the surface of rotating roller 8 is suppressed. In addition, rotating roller 8 is made of a hard material. Accordingly, even if an operation to remove ink 4 by means of rubber blade 10 is repeatedly performed, chemical deterioration due to ink 4, or wear or chipping of the surface of rotating roller 8 is less likely, and rotating roller 8 is prevented from turning into a dust generation source.

Here, ink 4 that has adhered to the surface of rotating roller 8 is wiped off from the surface of rotating roller 8 by upper end portion 10a of rubber blade 10, runs down along downwardly extending surface 10c of rubber blade 10, and drops from the tip end portion of protrusion 10b. Ink 4 that has dropped from the tip end portion of protrusion 10b is received by discarded ink reception portion 12.

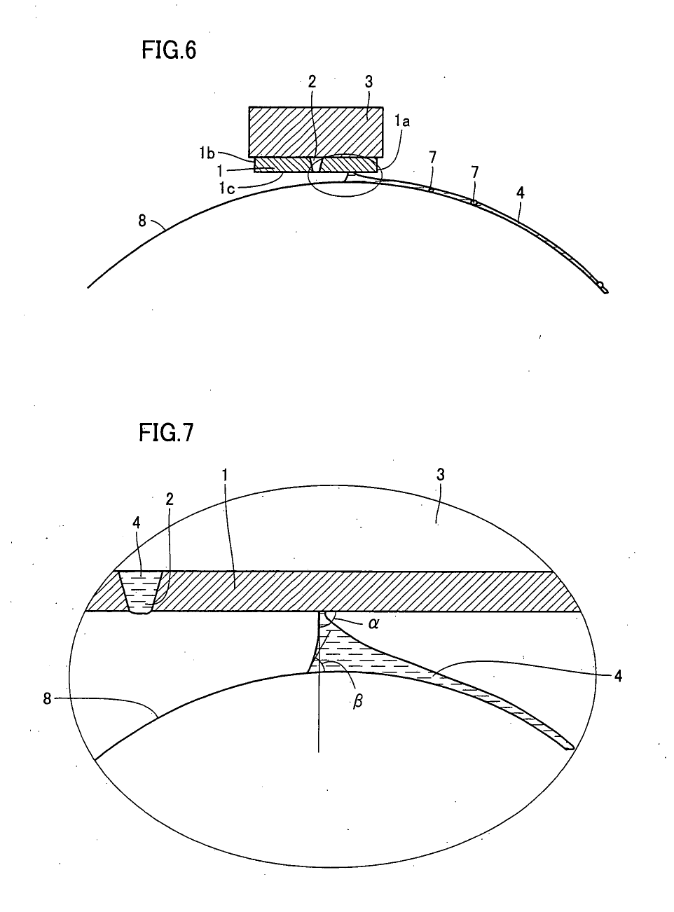

FIG. 6 is a cross-sectional view showing a fifth step of the step of cleaning inkjet head 3. As shown in FIG. 6, when ink 4 located between the surface of rotating roller 8 and nozzle plate 1 decreases, ink 4 in a columnar shape is formed between rotating roller 8 and nozzle plate 1. Ink 4 in a columnar shape is formed at a position in lower surface 1c of nozzle plate 1, closest to rotating roller 8.

FIG. 7 is an enlarged view of the area around nozzle plate 1 in the cross-sectional view shown in FIG. 6. As shown in FIG. 7, the area of contact between nozzle plate 1 and ink 4 gradually becomes smaller. Here, lower surface 1c of nozzle plate 1 is water-repellant-finished, and contact angle α between ink 4 and lower surface 1c of nozzle plate 1 is 90° or greater. Accordingly, in the vicinity of lower surface 1c of nozzle plate 1, the tail portion of ink 4 that fills the gap between rotating roller 8 and lower surface 1c of nozzle plate 1 on side surface 1a side and the tail portion thereof on side surface 1b side substantially stand erect with respect to lower surface 1c of nozzle plate 1.

Therefore, ink 4 that fills the gap between rotating roller 8 and nozzle plate 1 is in a columnar shape tapered from rotating roller 8 side toward nozzle plate 1 side. When rotating roller 8 further rotates, ink 4 in a columnar shape is cut.

The position where ink 4 in a columnar shape is cut is determined based on contact angle α and contact angle β. As contact angle α is greater than contact angle β, ink 4 in a columnar shape is cut at a position closer to nozzle plate 1 side.

Here, as the surface of rotating roller 8 is higher in wettability than lower surface 1c of nozzle plate 1 and the rotation speed of rotating roller 8 is set to 30 mm/s, contact angle θ is prevented from becoming greater than contact angle α during the cleaning step. If the rotation speed of rotating roller 8 is lower than 30 mm/s, ink 4 in a columnar shape formed between rotating roller 8 and nozzle plate 1 leaves lower surface 1c of nozzle plate 1 as a mass when ink 4 in a columnar shape is cut. Thus, ink residue is less likely to remain on the surface of lower surface 1c of nozzle plate 1.

In addition, as contact angle α is set to 90° or greater, when ink 4 in a columnar shape is cut, it is more likely that ink 4 is cut from the surface of nozzle plate 1 as a mass. Thus, ink 4 is less likely to remain as residue on lower surface 1c of nozzle plate 1. Further, even if ink 4 remains as residue on lower surface 1c of nozzle plate 1 when ink 4 in a columnar shape is cut, an amount of the ink is small and ink residue does not adversely affect recording such as pattern drawing.

Moreover, even if ink residue remains on lower surface 1c of nozzle plate 1, the ink residue is formed at a position distant from nozzle hole 2. Accordingly, influence on a recording operation by the ink residue is suppressed. Further, as the ink residue is formed at a position distant from nozzle hole 2, introduction of accretion 7 from nozzle hole 2 into inkjet head 3 is suppressed. Moreover, as positive pressure P2 applied to ink 4 in nozzle plate 1 is in a range from at least 0.001 KPa to at most 5 KPa, ink 4 is not ejected from nozzle hole 2 when ink 4 in a columnar shape formed between rotating roller 8 and nozzle plate 1 is cut, and spread of ink 4 over lower surface 1c of nozzle plate 1 is suppressed.

When cleaning of nozzle plate 1 is thus completed, rotating roller 8, rubber blade 10 and discarded ink reception portion 12 leave from the lower surface side of nozzle plate 1 and the step of cleaning inkjet head 3 ends.

In the first embodiment, rotating roller 8 is arranged to face nozzle plate 1 at a distance therefrom, however, the embodiment is not limited as such. Specifically, any movable portion arranged at a distance from lower surface 1c of nozzle plate 1 and arranged to be closest to lower surface 1c of nozzle plate 1 at a position in lower surface 1c of nozzle plate 1 distant from nozzle hole 2 may be adopted, without limited to rotating roller 8. In the cleaning step, the gap between the movable portion and nozzle plate 1 may be filled with ink 4, and thereafter ink 4 may be removed from the lower surface side of nozzle plate 1 while ink 4 is caused to adhere to the surface of movable portion by moving the movable portion.

According to inkjet-type recording apparatus 100 and cleaning apparatus 110 structured as above, by cleaning inkjet head 3, ink residue is less likely to remain on lower surface 1c of nozzle plate 1 and satisfactory cleaning can be performed.

Further, even if ink residue remains on lower surface 1c of nozzle plate 1, it is formed at a position distant from nozzle hole 2. Accordingly, when the recording operation is performed after cleaning, the ink residue is less likely to impede the recording operation and the recording operation can successfully be performed.

In addition, in filling the gap between rotating roller 8 and nozzle plate 1 with ink 4, as positive pressure P1 is applied to ink 4 in inkjet head 3, accretion 7 in nozzle hole 2 can be removed.

After the gap between rotating roller 8 and nozzle plate 1 is filled with ink 4, positive pressure P2 is applied to ink 4 in inkjet head 3. Accordingly, introduction of ink 4 and accretion 7 dispersed in ink 4 into inkjet head 3 through nozzle hole 2 can be suppressed and cleaning can successfully be performed.

As P2 is a relatively small positive pressure in a range from at least 0.001 KPa to at most 5 KPa, it is unlikely that ink 4 is newly ejected from nozzle hole 2 during the cleaning step and an amount of ink used in cleaning can be suppressed.

In addition, in the cleaning step of the present embodiment, as rotating roller 8 is arranged at a distance from nozzle plate 1, damage such as flaw on lower surface 1c of nozzle plate 1 or the like due to abutment of rotating roller 8 onto nozzle plate 1 can be suppressed. Thus, life of inkjet head 3 is improved and variation over time in ink ejection accuracy can be suppressed.

An amount of ink 4 used in the step of cleaning inkjet head 3 is suppressed to a small amount, because ink 4 filling the gap between nozzle plate 1 and rotating roller 8 arranged in proximity to each other is only used. In particular, as rotating roller 8 is less susceptible to impregnation with ink 4, an amount of ink 4 used in the cleaning step can be suppressed to a small amount. In addition, as rotating roller 8 is made of a hard material, even if the cleaning step is repeatedly performed, it is less likely that rotating roller 8 turns into a dust generation source, and inkjet head 3 can be cleaned well.

In addition, as ink 4 that has adhered to the surface of rotating roller 8 is satisfactorily wiped off by rubber blade 10, generation of thickened ink or aggregation of pigment at the surface of rotating roller 8 after the cleaning step is suppressed, and generation of thickened ink or aggregation of pigment on nozzle plate 1 is suppressed.

### Second Embodiment

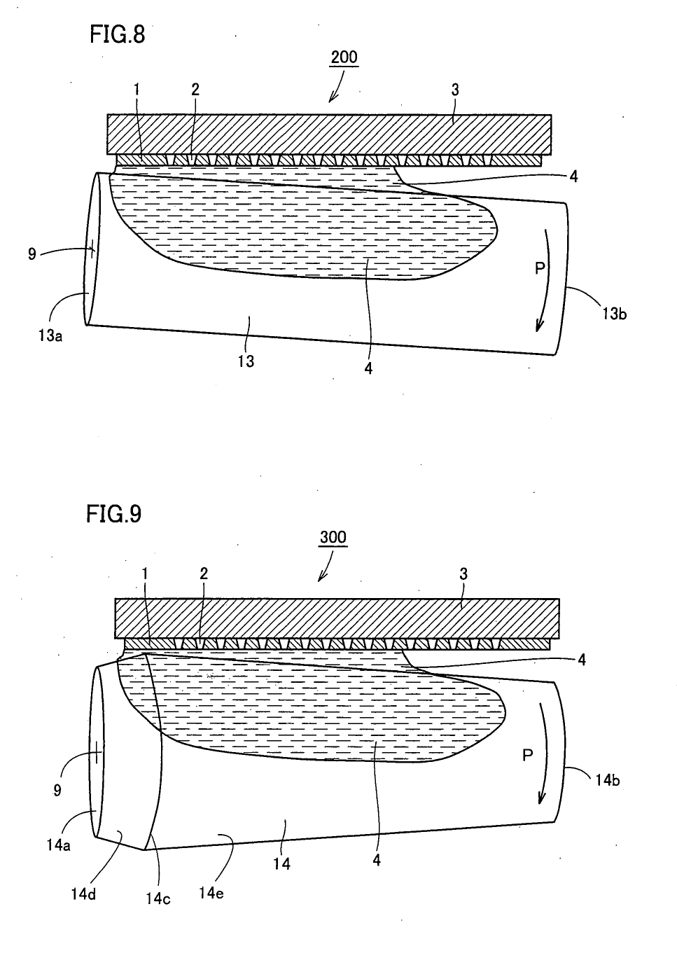

FIG. 8 is a cross-sectional view of an inkjet-type recording apparatus 200 according to a second embodiment. As shown in FIG. 8, inkjet-type recording apparatus 200 includes a cylindrical rotating roller 13 arranged on the lower surface side of nozzle plate 1. Rotating roller 13 includes an annular axial end surface 13a, that is formed on one end surface in a direction of rotation axis 9, and an annular axial end surface 13b, that is formed on the other end surface in the direction of rotation axis 9.

A plurality of nozzle holes 2 are formed in the lower surface of nozzle plate 1 along the longitudinal direction of nozzle plate 1. The structure is otherwise the same as in the first embodiment.

Inkjet head 3 is cleaned by using inkjet-type recording apparatus 200 structured as above. Initially, in the first step of the cleaning step, rotating roller 13 is arranged to face lower surface 1c of nozzle plate 1 in a non-contact state.

Here, rotating roller 13 is arranged such that a distance between lower surface 1c of nozzle plate 1 and rotating roller 13 increases from axial end surface 13a side toward axial end surface 13b side. In other words, rotation axis 9 of rotating roller 13 is inclined such that rotation axis 9 is more distant from lower surface 1c of nozzle plate 1 on the axial end surface 13b side than on axial end surface 13a side. Accordingly, a distance between rotating roller 13 and nozzle plate 1 is smallest between a circumferential surface on axial end surface 13a side in the circumferential surface of rotating roller 13 and lower surface 1c of nozzle plate 1. Thus, an area where rotating roller 13 and nozzle plate 1 are in proximity to each other is narrow and substantially as small as a spot.

In addition, the area where nozzle plate 1 and rotating roller 13 are in proximity to each other is located outside nozzle hole 2 formed at the longitudinal end portion of nozzle plate 1, among a plurality of nozzle holes 2 formed in the lower surface of nozzle plate 1.

In the second step of the cleaning step, a positive pressure is applied to ink 4 in inkjet head 3 so as to fill the gap between the surface of rotating roller 13 and lower surface 1c of nozzle plate 1 with ink 4. In addition, in the third step of the cleaning step, rotating roller 13 rotates at a speed not higher than 30 mm/s. As rotating roller 13 rotates, ink 4 adheres to the surface of rotating roller 13. Accordingly, the volume of ink 4 filling the gap between nozzle plate 1 and the surface of rotating roller 13 decreases with rotation of rotating roller 13.

Rotating roller 13 is arranged more distant from lower surface 1c of nozzle plate 1 on axial end surface 13b side than on axial end surface 13a side. Therefore, the tail portion of ink 4 that fills the gap between the surface of rotating roller 13 and lower surface 1c of nozzle plate 1 on axial end surface 13b side is displaced toward the position at which rotating roller 13 is closest to nozzle plate 1.

When viewed in cross-section from axial end surface 13a side, as in the first embodiment, the width of ink 4 that fills the gap between rotating roller 13 and nozzle plate 1 in the circumferential direction of rotating roller 13 becomes smaller with rotation of rotating roller 13. When viewed in cross-section from axial end surface 13a side, center of gravity of ink 4 in a columnar shape formed between rotating roller 13 and nozzle plate 1 is displaced toward the position at which rotating roller 13 is closest to nozzle plate 1.

Thus, when rotating roller 13 rotates, ink 4 that fills the gap between rotating roller 13 and nozzle plate 1 is displaced toward the position where rotating roller 13 is closest to nozzle plate 1. Here, the area where rotating roller 13 is closest to nozzle plate 1 is a narrow area substantially as small as a spot. Accordingly, as rotating roller 13 rotates, ink 4 between nozzle plate 1 and rotating roller 13 converges toward the narrow area substantially as small as a spot.

In the fourth step of the step of cleaning inkjet head 3, ink 4 that has adhered to the surface of rotating roller 13 is removed. Then, in the fifth step of the step of cleaning inkjet head 3, ink 4 in a columnar shape formed between rotating roller 13 and nozzle plate 1 leaves nozzle plate 1 in the area where rotating roller 13 is closest to nozzle plate 1.

Here, as the area where rotating roller 13 is closest to nozzle plate 1 is a narrow area substantially as small as a spot, a portion of contact between ink 4 and nozzle plate 1 is substantially as small as a spot when ink 4 in a columnar shape formed between rotating roller 13 and nozzle plate 1 leaves the lower surface of nozzle plate 1.

Therefore, when ink 4 in a columnar shape leaves the lower surface of nozzle plate 1, ink 4 is less likely to remain as residue on the lower surface of nozzle plate 1.

According to inkjet-type recording apparatus 200 structured as above, it is less likely that ink residue is formed on the lower surface of nozzle plate 1 when ink 4 in a columnar shape leaves the lower surface of nozzle plate 1, and cleaning of inkjet head 3 can satisfactorily be performed. In addition, even if residue of ink 4 is formed on the lower surface of nozzle plate 1, introduction of residue of ink 4 into nozzle hole 2 is less likely, because the area where rotating roller 13 is in proximity to nozzle plate 1 is distant from the area where nozzle hole 2 is formed along the longitudinal direction of nozzle plate 1. It is noted that, as inkjet-type recording apparatus 200 according to the second embodiment is structured in a manner the same as inkjet-type recording apparatus 100 according to the first embodiment, a function and effect the same as in the first embodiment above can be obtained.

### Third Embodiment

A third embodiment of the present invention will be described with reference to FIG. 9. FIG. 9 is a side, cross-sectional view of an inkjet-type recording apparatus 300 according to the third embodiment. As shown in FIG. 9, nozzle plate 1 and a rotating roller 14 arranged on the lower surface side of nozzle plate 1 are provided. Rotating roller 14 has a large diameter portion 14c with a largest diameter formed on one axial end surface 14a side.

Rotating roller 14 includes a decreasing-diameter portion 14d formed between large diameter portion 14c and an axial end surface 14a and having a diameter decreasing from large diameter portion 14c toward axial end surface 14a side. In addition, rotating roller 14 includes a decreasing-diameter portion 14e formed between large diameter portion 14c and an axial end surface 14b and formed to have a diameter decreasing from large diameter portion 14c toward axial end surface 14b. The structure is otherwise the same as in the second embodiment, and the same element has the same reference character allotted.

In cleaning inkjet head 3 by using inkjet-type recording apparatus 300 structured as above, initially, in the first step of the step of cleaning inkjet head 3, rotating roller 14 is arranged on the lower surface side of nozzle plate 1 in a non-contact state.

Here, rotation axis 9 of rotating roller 14 is arranged substantially parallel to the lower surface of nozzle plate 1. Large diameter portion 14c of rotating roller 14 is arranged at a position distant from the area in the lower surface of nozzle plate 1 where nozzle hole 2 is formed along the longitudinal direction of nozzle plate 1. In addition, decreasing-diameter portion 14e of rotating roller 14 is arranged to face the area in the lower surface of nozzle plate 1 where nozzle hole 2 is formed.

Accordingly, as to the area in the lower surface of nozzle plate 1 where nozzle hole 2 is formed, arrangement is such that a distance between rotating roller 14 and nozzle plate 1 gradually increases from axial end surface 14a side toward axial end surface 14b side. Then, in the second step of the step of cleaning inkjet head 3, ink 4 fills the gap between rotating roller 14 and nozzle plate 1.

In addition, in the third step of the step of cleaning inkjet head 3, rotating roller 14 rotates, so that ink 4 that fills the gap between rotating roller 14 and nozzle plate 2 is gradually caused to adhere to the surface of rotating roller 14. In the fourth step of the step of cleaning inkjet head 3, ink 4 that has adhered to the surface of rotating roller 14 is removed. Then, in the fifth step of the step of cleaning inkjet head 3, rotating roller 14 further rotates, so that ink 4 in a columnar shape formed between rotating roller 14 and nozzle plate 1 leaves nozzle plate 1.

In inkjet-type recording apparatus 300 structured as above, the area where rotating roller 14 is closest to the lower surface of nozzle plate 1 is narrow as in inkjet-type recording apparatus 200 according to the second embodiment. In addition, the area where rotating roller 14 is closest to nozzle plate 1 is positioned at a distance from the area of nozzle plate 1 where nozzle hole 2 is formed, in the longitudinal direction of nozzle plate 1, as in inkjet-type recording apparatus 200 according to the second embodiment. Moreover, as in recording apparatus 200 in the second embodiment, as to the area of nozzle plate 1 where nozzle hole 2 is formed, arrangement is such that a distance between rotating roller 14 and nozzle plate 1 gradually increases from axial end surface 14a side toward axial end surface 14b side.

Therefore, inkjet-type recording apparatus 300 according to the third embodiment can attain a function and effect the same as that in inkjet-type recording apparatus 200 according to the second embodiment.

Embodiments of the present invention have been described above, however, it should be understood that the embodiments disclosed herein are illustrative and non-restrictive in every respect. The scope of the present invention is defined by the terms of the claims, and is intended to include any modifications within the scope and meaning equivalent to the terms of the claims.

### INDUSTRIAL APPLICABILITY

The present invention is suitable for an inkjet-type recording apparatus, an apparatus for cleaning an inkjet head portion, and a method of cleaning an inkjet head portion.

1: An inkjet-type recording apparatus, comprising:
an inkjet head portion making a recording on a recording medium by injecting ink from a nozzle hole in a nozzle plate;
an ink tank supplying said inkjet head portion with ink; and
a rotating roller for cleaning said nozzle plate of said inkjet head portion;
said rotating roller being arranged to face said nozzle plate of said inkjet head portion in a non-contact state, and said rotating roller being arranged to be closest to said nozzle plate in an area other than said nozzle hole.

2: The inkjet-type recording apparatus according to claim 1, wherein
a position where said rotating roller is closest to said nozzle plate is displaced with respect to said nozzle hole in a direction of rotation of said rotating roller.

3: The inkjet-type recording apparatus according to claim 1, wherein
a distance between said rotating roller and said nozzle plate increases from one axial end surface of said rotating roller toward another axial end surface.

4: The inkjet-type recording apparatus according to claim 1, wherein
a contact angle between said ink and said rotating roller is smaller than a contact angle between said ink and said nozzle plate.

5: The inkjet-type recording apparatus according to claim 1, wherein
a contact angle between said ink and said nozzle plate is at least 90°.

6: The inkjet-type recording apparatus according to claim 1, further comprising an ink removal portion removing said ink that has adhered to a surface of said rotating roller by contacting the surface of said rotating roller.

7: An apparatus for cleaning an inkjet head portions, comprising:
a rotating roller arranged to face a nozzle plate for inkjet in a non-contact state and arranged to be closest to said nozzle plate in an area other than a hole in said nozzle plate;
an ink removal portion removing ink that has adhered to a surface of said rotating roller; and
an ink storage portion storing said ink that has been removed by said ink removal portion.

8: A method of cleaning an inkjet head portion with a movable portion arranged to face a nozzle plate at a distance therefrom, by removing ink from said nozzle plate while the ink between said movable portion and said nozzle plate is caused to adhere to a surface of said movable portion by moving said movable portion.

9: The method of cleaning the inkjet head portion according to claim 8 by using a rotating roller, the inkjet head portion having a nozzle hole formed, comprising the steps of:
arranging said rotating roller to face said inkjet head portion in a non-contact state;
filling a gap between said nozzle plate and said rotating roller with ink ejected from said nozzle hole;
gradually moving said ink filling the gap between said nozzle plate and said rotating roller from a position on said nozzle plate toward a side of said rotating roller; and
removing said ink filling the gap between said rotating roller and said nozzle plate in an area other than where said nozzle hole is formed, in an area on said nozzle plate.

10: The method of cleaning the inkjet head portion according to claim 9, wherein
said rotating roller rotates at a speed of at most 30 mm/s.

11: The method of cleaning the inkjet head portion according to claim 9, wherein
said ink is removed while a positive pressure is applied to the ink in said inkjet head portion.
